(19) United States
(12) Patent Application Publication
(10) Pub. No.: US 2003/0075387 A1
(43) Pub. Date: Apr. 24, 2003

(54) Wafer loading device

(76) Inventors: Chung-Chiang Wang, Hsinchu (TW); Ming-ta Chen, Hsinchu (TW); Ming Kan Ju, Hsinchu (TW); Ming-Kuan Kao, Hsinchu (TW)

Correspondence Address: BIRCH STEWART KOLASCH & BIRCH, PO BOX 747, FALLS CHURCH, VA, 22040-0747, US

(21) Appl. No.: 09/982,868

(22) Filed: Oct. 22, 2001

(51) Int. Cl. B66B 9/02

(52) U.S. Cl. 187/250

(57) ABSTRACT

A wafer loading device having improved lift-pin structure is provided to solve the particle clogging problems. The wafer loading device includes a pedestal with a plurality of holes for allowing the lift pins to move in vertical direction. The structure of the lift pins includes a neck portion connecting a head portion and a support portion. The neck portion is narrower than the support portion for leaving a gap in the hole. The lift ring is driven by a lift driver and disposed beneath the pedestal for controlling the movement of the lift pins.

### BACKGROUND OF THE INVENTION

1. Field of Invention

The invention relates to a wafer loading device and, more particularly to a wafer loading device having an improved structure of the lift pins for placing a wafer on top of a pedestal.

2. Description of the Related Arts

Wafer loading devices are widely used for semiconductor fabrication. For example, in a thin film deposition process, such as physical vapor deposition (PVD) or chemical vapor deposition (CVD), a wafer loading device is used to load a wafer while performing the thin film deposition process in a chamber. The uniformity of a deposited thin film on the wafer is greatly determined by the position of the wafer on the pedestal of a wafer loading device.

As shown in FIG. 1A and FIG. 1B, a conventional wafer loading device 1 mainly includes a pedestal 11, multiple lift pins 12, a lift ring 13, and a lift driver 14. The pedestal 11 can be a heater to increase the temperature of the wafer 10 so that a thin film can be more uniformly deposited on the surface of the wafer 10. The lift ring 13 is driven by the lift driver 14 to move upwards and downwards. The lift pins 12 suspend on the pedestal 11 and on the same top surface with the pedestal 11 and protrude the bottom surface of the pedestal 11. When the lift driver 14 drives the lift ring 13 to move upwards, the lift ring 13 pushes the lift pins 12 upwards to lift the wafer 10. When the lift driver 14 descends, it leaves the lift pins 12 suspending on the pedestal 11 and then loads the wafer 10 on the pedestal 11.

With reference to FIG. 2, the conventional lift pin 12 has a head portion 121 and a rod portion 122 which is in a shape of cylinder. When the lift driver 14 drives the lift ring 13 to move downwards, the lift ring 13 gradually departs from the lift pins 12. At that moment, the lift pins 12 fall due to the gravity. If any lift pin 12 does not descend completely, the wafer 10 cannot be evenly disposed on the surface of the pedestal 11, resulting in an unbalanced deposition.

The reason why some of the lift pins 12 cannot readily fall is because particles 16 generated during the thin film deposition reactions are likely to pile up and clog in the gap 111 of the hole 17 after a long term of use. More specifically, the particles 16 clogged in the gap 111 may cause a rough movement of the lift pins 12 or even cause the movement of the lift pins 12 to get stuck while moving upwards or downwards. Most wafer loading devices available on the market do not provide efficient ways to detect the situation of the lift pins 12 during routine operations.

To solve the above problems, some equipment vendors made some improvements by changing the structure of the lift pins. For example, they increase the size of the gap by shrinking the diameter of the rod portion of the lift pins. As shown in FIG. 3, the rod portion 122 of the lift pin 12 is a cylinder with a smaller diameter so as to have a bigger gap 111 between the lift pin 12 and the pedestal 11. Thus, the particles 16 will not be clogged at the angle 112. However, the improved structure of the lift pins also creates new problems. As the gap 111 increases, the lift pins 12 are likely to wiggle when they move in vertical direction. As a result, it gets more difficult to keep the wafer 10 stable while lifting it up and place it in position on the pedestal.

### SUMMARY OF THE INVENTION

Accordingly, it is an object of the invention to provide a wafer loading device that can keep the wafers in position while being loaded on the pedestal.

Another object of the invention is to provide a wafer loading device in which the lift pins can be driven smoothly in vertical direction.

To achieve the above objects, the invention discloses a wafer loading device which includes a pedestal with a plurality of holes for allowing the lift pins to move in vertical direction. The structure of the lift pins includes a neck portion connecting a head portion and a support portion. The neck portion is narrower than the support portion for leaving a gap in the hole. The lift ring is driven by a lift driver and disposed beneath the pedestal for controlling the movement of the lift pins.

### BRIEF DESCRIPTION OF THE DRAWINGS

FIG. 1A is a schematic diagram showing the cross sectional view of a conventional wafer loading device;

FIG. 1B is a schematic diagram showing the cross sectional view of the conventional wafer loading device;

FIG. 2 is an enlarged view showing the structure of a conventional lift pin;

FIG. 3 is an enlarged view showing the structure of a conventional lift pin;

FIG. 4 is a schematic diagram showing the structure of the lift pin according to a preferred embodiment of the invention; and

FIG. 5 is a schematic diagram showing the structure of the lift pin.

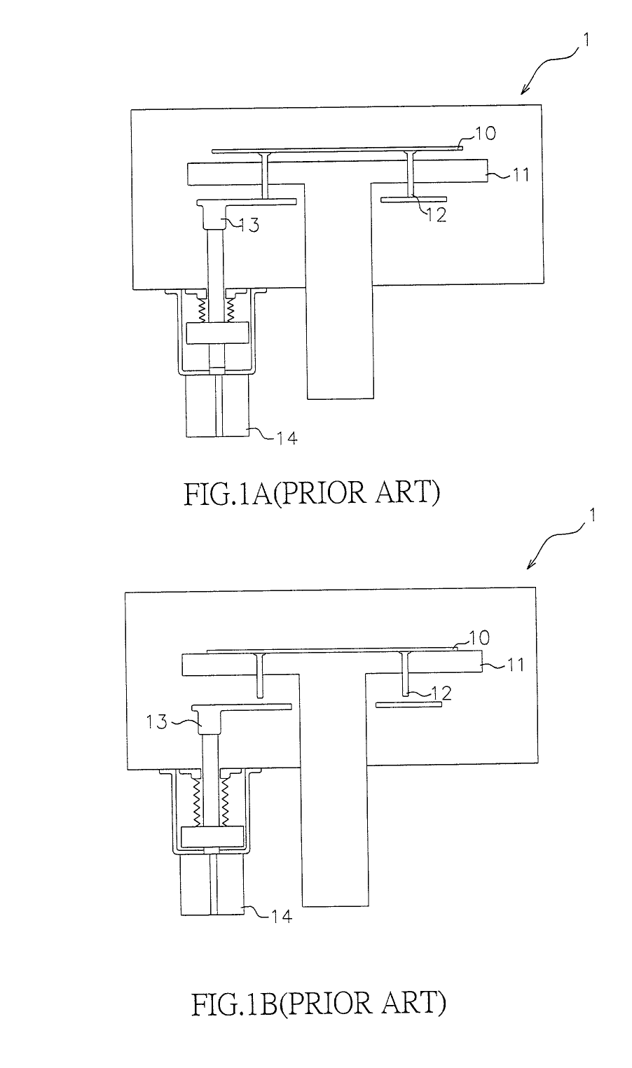

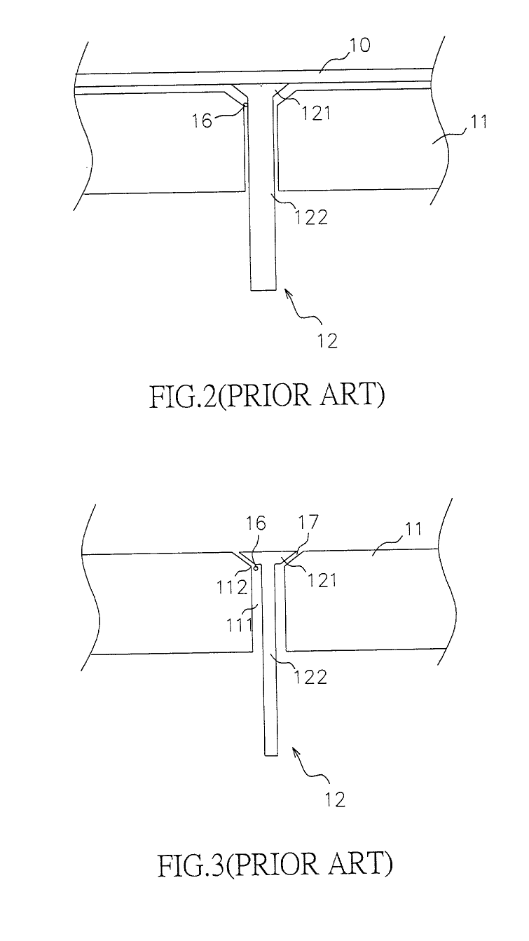

### DETAILED DESCRIPTION OF THE PREFERRED EMBODIMENT OF THE INVENTION

The main structure of the wafer loading device remains the same as those described in the description of the prior arts. The wafer loading device includes a pedestal with a plurality of holes each for allowing a lift pin to move in vertical direction for lifting a wafer. The lift ring is disposed beneath the pedestal for controlling the movement of the lift pin. A lift driver is connected to the lift ring for driving the lift ring in vertical direction.

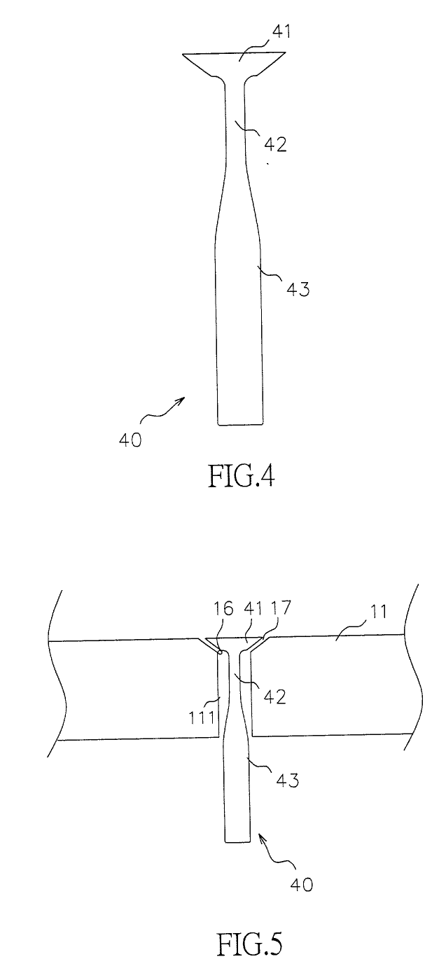

In the wafer loading device, the improvement of the invention is in the structure of the lift pins. Refer to FIG. 4, the lift pin 40 according to the preferred embodiment of the invention has a structure which includes a head portion 41, a neck portion 42 and a support portion 43 in an order from top to bottom. The neck portion 42 and the support portion 43 are connected in a shape like a long neck bottle. Since the neck portion 42 is narrower than the support portion 43, it leaves a gap 111 large enough in the hole 17 to allow particles 16 passing through the hole 17 without being clogged as illustrated in FIG. 5.

Refer to FIG. 5, the hole 17 of the pedestal 11 has a wide opening on the top for fitting the head portion 41 of the lift pin 40. When the lift pin 40 descends to the bottom, the head portion 41 fits the wide opening so well that it forms a planar surface on the pedestal 11. Moreover, since the support portion 43 is relatively large and at a lower position, so it can provide stable support to the lift pin 40 without causing waggling movement while lifting a wafer. The weight of the support portion 43 also helps to drive the lift pin 40 down to the bottom more efficiently. In addition, the head portion 41, the neck portion 42 and the support portion 43 of the lift pin 40 can be formed as a solid body by molding.

To sum up, due to the improved structure of the lift pins, the wafer loading device of the preferred embodiment of the invention is free from the particle clogging problems and capable of providing stable support for the wafer.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed is:

1. A wafer loading device comprising:
a pedestal with a plurality of holes, each of said plurality of holes having a lift pin, said lift pin having a neck portion connecting a head portion and a support portion, and said neck portion being narrower than said support portion;
a lift ring disposed beneath said pedestal for controlling the movement of said lift pin; and
a lift driver connected to said lift ring for driving said lift ring in vertical direction.
